(19) United States
(12) Patent Application Publication
(10) Pub. No.: US 2014/0250630 A1
(43) Pub. Date: Sep. 11, 2014

(54) Grip assist device

(71) Applicant: Joseph K. Nugent, Rayne, LA (US)

(72) Inventor: Joseph K. Nugent, Rayne, LA (US)

(21) Appl. No.: 13/815,525

(22) Filed: Mar. 8, 2013

(51) Int. Cl. B25G 1/02

(52) U.S. Cl. CPC B25G 1/02
USPC 16/110.1; 29/428

(57) ABSTRACT

A grip brace having an adjustable base is provided, in which the base is secured around the user's wrist. The brace is attached to at least one finger of a user's hand to prior to securing the base to the wrist in order to hold one end of the base in place while the other end is pulled. At least one wrap is provided to cover and apply pressure to the user's hand as the hand grips the handle or rod-such as the handle of a tennis racquet, fishing pole, table tennis paddle, broom, rake or other devices-and attaches to the main member or other portion of the grip brace, by means of a fastener, thereby supporting the user's grip of the rod or handle. Further, the base, the at least one arm, both, or the entire grip brace may be comprised of an elastic material such that the amount of support for the wrist and hand may be increased by stretching a section of the brace as desired, thereby increasing the compressive force on the effected portion of the user's hand, wrist, or arm.

### STATEMENT REGARDING FEDERALLY SPONSORED RESEARCH OR DEVELOPMENT

Not Applicable

### FIELD OF DISCLOSURE

This disclosure relates to devices and methods for assisting persons with reduced strength, dexterity and/or coordination in their hands to securely grip devices having handles, poles, or rods.

### BACKGROUND

The embodiments of the present disclosure relate generally to wearable articles for securing a user's hand to a handle, rod, or pole, such as a tennis racquet, fishing pole or other related device. Further, the disclosed embodiments relate to assisting a user with hand or arm weakness or any limitation to the hands' coordination or dexterity. Users with such conditions may include, without limitation, children, senior adults, persons with arthritis or other joint diseases, persons with neuromuscular disease, paraplegics, quadriplegics or any number of other conditions or maladies, and regardless of whether the effect on the hand, wrist and/or arm is short term or long term.

People with such reductions in function may have difficulty gripping devices such as tennis racquets, table tennis paddles, fishing poles, handguns or other devices with similar grip structures. Such difficulty hinders or prevents the enjoyment of activities that require such devices. Moreover, holding such devices while performing the activity may require additional support for the fingers, hand, and or wrist while maintaining sufficient joint flexibility and skin sensitivity to effectively use the device.

Prior attempts to help users with weakened grips have primarily focused on a single sport or activity. Such devices may be difficult to install or don, particularly for users with reduced hand strength, coordination or dexterity, due to metal rods, forearm attachments, or other cumbersome elements. Further such devices incorporate multiple parts and are relatively expensive to manufacture. Therefore, there exists a need for a grip assist device that is simple to put on the user and is inexpensive to manufacture.

### SUMMARY OF THE DISCLOSED EMBODIMENTS

The present embodiments provide a firm grasp for a user's hand around the selected handle, rod or grip while requiring only a short series of simple, easily performed steps for donning the device. The devices of the present disclosure are configured such that these steps may be performed by a user with limited hand dexterity even when combined with limited hand or arm strength. Further, certain of the disclosed embodiments may be easily manufactured using minimal numbers of components and are of relatively low cost when compared to prior art devices.

A grip brace having an adjustable base is provided, in which the base is secured around the user's wrist. The brace is attached to at least one finger of a user's hand to prior to securing the base to the wrist in order to hold one end of the base in place while the other end is pulled. At least one wrap is provided to cover and apply pressure to the user's hand as the hand grips the handle or rod-such as the handle of a tennis racquet, fishing pole, table tennis paddle, broom, rake or other devices-and attaches to the main member or other portion of the grip brace, by means of a fastener, thereby supporting the user's grip of the rod or handle. Further, the base, the at least one arm, both, or the entire grip brace may be comprised of an elastic material such that the amount of support for the wrist and hand may be increased by stretching a section of the brace as desired, thereby increasing the compressive force on the effected portion of the user's hand, wrist, or arm.

### BRIEF DESCRIPTION OF THE DRAWINGS

In the detailed description of the embodiments presented below, reference is made to the accompanying drawings, in which:

FIG. 1 depicts one embodiment of a grip brace of the present disclosure.

FIG. 2 depicts a diagram of an embodiment grip brace attached to a user's wrist, including a rod or handle held in the user's hand.

FIG. 3 depicts a step in donning an embodiment whereby the user attaches the grip brace to the user's wrist.

FIG. 4 depicts another step in donning one embodiment whereby the user grips a rod or handle, a wrap is passed around the user's hand and fingers and secured to another part of the grip brace.

FIG. 5 depicts another step in donning one illustrative embodiment of the present disclosure whereby an additional wrap is passed around the at least a portion of the user's hand and fingers and secured to another part of the grip brace.

### DETAILED DESCRIPTION OF THE EMBODIMENTS

Illustrative embodiments are described below. In the interest of clarity, not all features of an actual implementation are described in this specification. It will be appreciated that in the development of any embodiment, numerous implementation-specific decisions must be made to achieve the developer's specific goals, which will vary from one implementation to another. Moreover, it will be appreciated that such a development effort might be complex and time-consuming, but would nevertheless be a routine undertaking for those of ordinary skill in the art having the benefit of this disclosure.

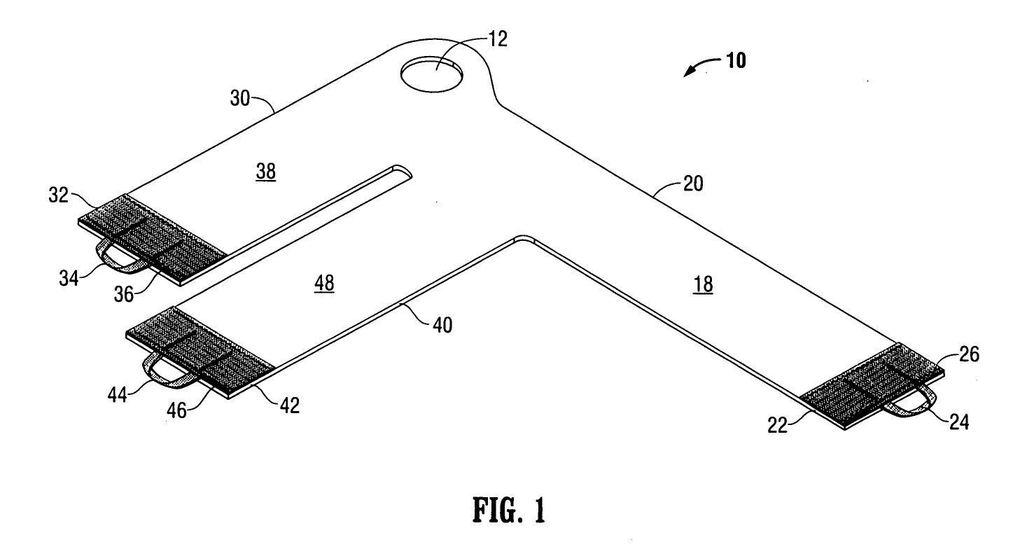

Referring now to FIG. 1, a diagram of an embodiment of a grip brace o the present disclosure is shown. The illustrated grip brace (10) has a base (20), and a plurality of wraps (30, 40) connecting to base (20). In one embodiment, the wraps are connected to the base such that the longer dimension of wraps (30, 40) is approximately perpendicular to the longer dimension of the base (20). However, the angle of the wrap or wraps relative to the base can be any value provided that the wraps provide the necessary support for the hand gripping a handle as described below.

The base (20) comprises of a base end (22) and the base end (32) further comprises a base end loop (24) and a base end fastener (26). The base end loop (24) may function as a gripping member and facilitate the user's efforts to position the base, base end (22) and the base end fastener (26) at a desired location or in a desired configuration relative to the user's wrist or hand, or relative to a feature of the grip brace (10), as further described below. The base end fastener (26) comprises one section of a fastener such as the hook section of a Velcro® fastener, the button hole necessary for engaging a button, a metal hook for connecting to a corresponding loop, either side of a snap fastener, or any other fastener. Such fasteners are well known and the fastener may be selected from any type that is usable by the wearer of the device or by a person assisting the wearer to don the device.

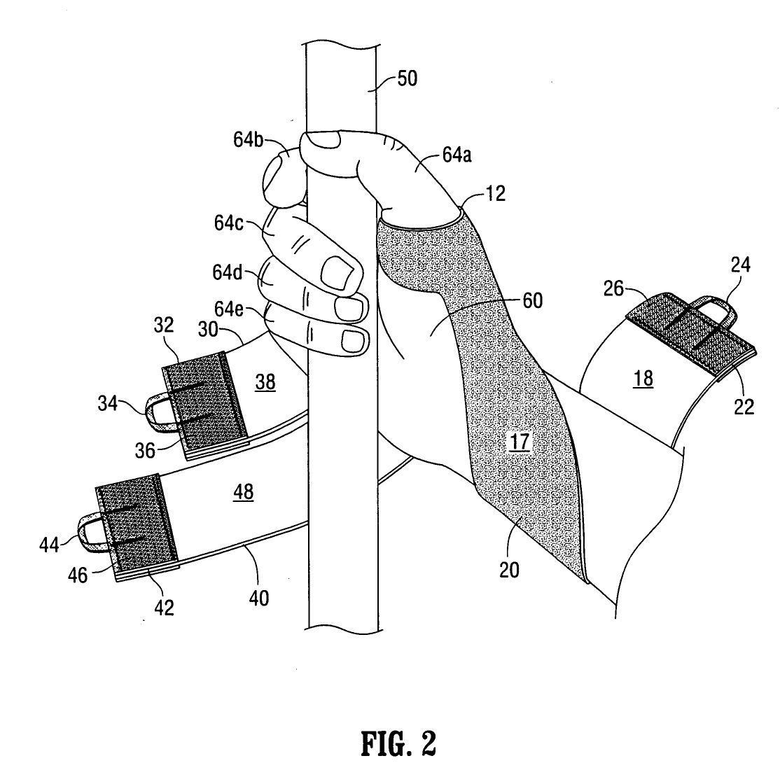

The base (20) further comprises a first face \(18), which may contact the user's skin or clothing worn between the user's skin and the grip brace, and a second face (17) (see FIGS. 2-5). In one embodiment, the first face (18) comprises a material that limits or prevents irritation to the skin in order to facilitate user comfort. The second face (17) includes the connecting element for engaging the base end fastener (26). In the illustrated embodiment, the base end fastener (26) comprises the hook surface for a Velcro® fastener and the connecting element comprises the loop surface that the hook surface of base end fastener (26) may engage.

The illustrated embodiment comprises two wraps (30, 40). Grip braces having a single wrap or more than two wraps are also within the scope of the present disclosure. Each wrap has a wrap end (32, 42) and each wrap end (32, 42) further comprising a wrap end loop (34, 44) and a wrap end fastener (36, 46). Each wrap end loop, when present, may function as a gripping member and facilitate the user's efforts to, typically separately, position each wrap (30, 40), wrap end (32, 42) and the wrap end fastener (36, 46) at a desired location or in a desired configuration relative to the user's wrist or hand, or relative to a feature of the grip brace, as further described below. The wrap end fastener (36, 46) comprises one section of a fastener such as the hook section of a Velcro® fastener, a button hole or holes for engaging a button, a metal hook for connecting to a corresponding loop, either side of a snap fastener, or an appropriate section of any other fastener. Such fasteners are well known and the fastener may be selected from any type that is usable by the wearer of the device or by a person assisting the wearer to don the device.

Each wrap (30, 40) further comprises a first face (38, 48) which may contact the user's skin or clothing worn between the user's skin and the grip brace, and in some embodiments, the first face (38, 48) of one or more wraps (30, 40) comprises a material that limits or prevents irritation to the user's skin in order to facilitate user comfort. Each wrap (30, 40) also comprises a second face (37, 47) which may include one or more connecting elements for engaging one or more wrap end fasteners (36, 46). In the illustrated embodiment, the each wrap end fastener (36, 46) comprises the hook surface for a Velcro® fastener and the connecting element comprises the loop surface that the hook surface of base end fastener (36, 46) may engage.

The grip brace (10) may further comprises an anchor, shown in the illustrated embodiment as a passageway (12) through grip brace (10). It will be appreciated that the anchor may also comprise a loop connected to the first face (18) or to an edge of the base (20) or one or more of the wraps (30, 40). Further, the anchor may be formed by configuring the base as a closed loop, for example by sewing the ends of the base together, and sliding the closed loop over the user's hand. It will be appreciated that the internal circumference of such closed loop must be at least less than the circumference of the user's hand adjacent to the wrist in order for the base (20) to secure the grip brace to the wrist. Further, in such embodiments, the base will comprise and elastic material such that, in the relaxed position, the internal circumference of the base (20) is smaller than the user's wrist but is capable of expanding to pass over the user's hand and secure against the wrist by the compressive force of the elastic.

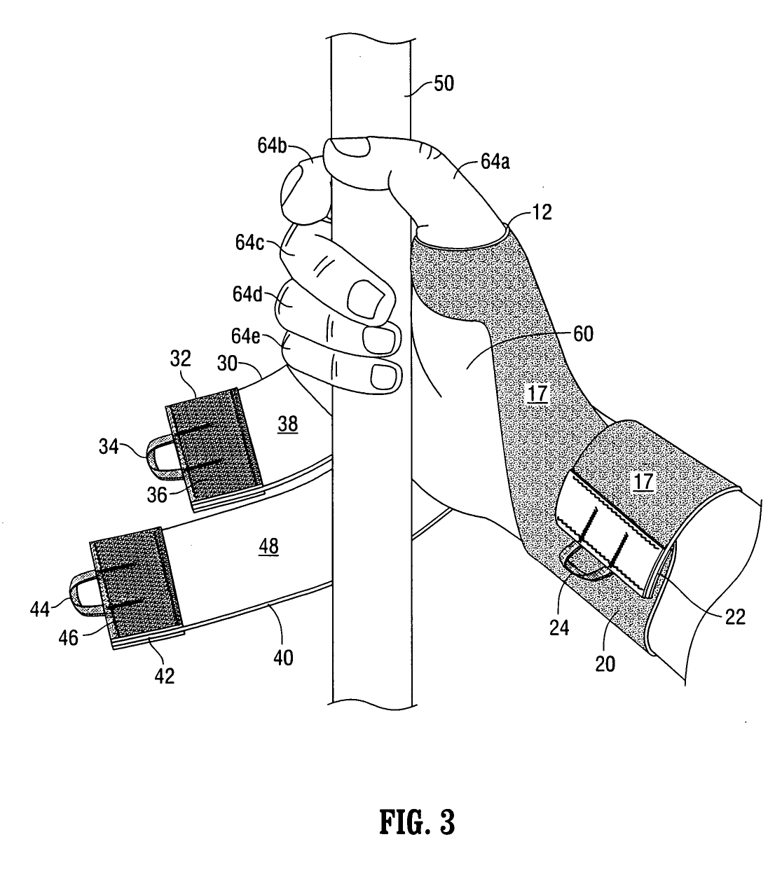

FIGS. 2 and 3 illustrate an embodiment of the present disclosure as it is being put on a user's hand. In the illustrated embodiment, a user's thumb (64a) passes through the passageway (12), which anchors an end of the base (20) adjacent to the thumb (64a) using passageway (12). Multiple fingers and/or fingers other than the thumb (64b-64e) may be used to engage the anchor. It will be appreciated that the base (20) is installed over the thumb with the first face (18) placed in contact with the skin, leaving the receiving or connector elements on the outward side and available to the base end fastener (26). A second hand, such as the user's other hand or the hand of an assistant (not shown), pulls the base end (22), such as by engaging base end loop (24) with a finger or fingers to wrap the base (20) around the wrist. Further, in some embodiments the base end gripper loop (24) or similar gripping element allow for the base (20) to be wrapped around the user's wrist using only one finger to engage the based end gripper loop (24) or other gripper element.

It will be appreciated that the illustrated embodiment may be donned using no more than two fingers of the user's opposing hand—e.g. the hand not intended to wear the grip brace (10). Specifically, the passageway (12) can be placed over the thumb (64a) of the user's hand by grasping the grip brace (10) with two fingers and either placing the passageway (12) over the thumb (64a) or by moving the thumb through the passageway. Alternatively, the grip brace (10) could be placed on a table, the user's leg, or other structure and the wearing hand simply manipulated such that the thumb (64a) is passed through the passageway (12) without manipulation by the user's opposing hand. A single finger from the opposing hand can then be engaged on the gripper element, such as base end gripper loop (24) to move, stretch and engage the base end fastener (26) with the selected connector element, or the selected location on the continuous connector element embodied by the Velcro® loop fabric of second face (17).

Base end (22) is pulled until base end fastener (26) is positioned adjacent to a selected receiving or connector element and the base end fastener (26) is engaged to the fastener element. In the illustrated embodiment, the base end fastener (26) is a hook section of a Velcro® fastener and the second face (17) includes Velcro® loop fabric over substantially its entire surface. Thus, in this embodiment, the second face (17) is a continuous receiving or connector element and or serves as a series of connector elements. Thus, the base (20) of the illustrated embodiment is continuously adjustable so that the device can be secured to the user's wrist relatively loosely-by, for example, connecting the base end (22) to the other of the base (20) adjacent to the passageway (12)—or relatively tightly-by, example, pulling the base end (22) past the passageway (12) until the base (20) applies the compression, or tightness, around the wrist that is desired by the user. The terms “loosely” and “tightly” are relative terms to illustrate a possible effect of moving the location at which the wrap end (22) is ultimately secured to the connector element and the embodiments of the present disclosure are not limited in any way by such description.

While FIGS. 2 and 3 illustrate securing of base (20) to the wrist while the user's hand is gripping the handle or pole (50), the base (20) may be donned prior to the user gripping or grasping the pole, handle, or rod.

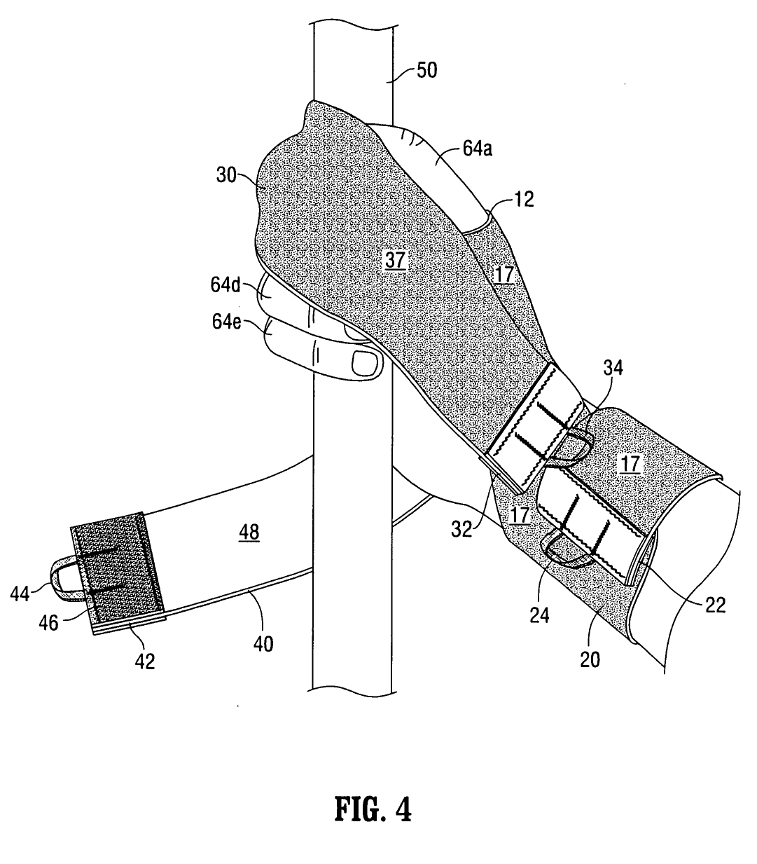

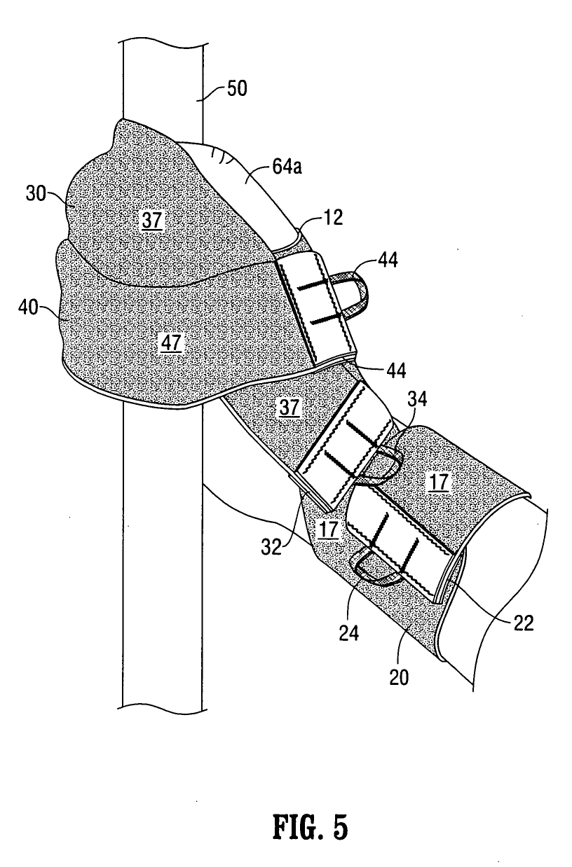

FIGS. 4 and 5 illustrate securing the handle, pole, or rod in the user's hand using one or more wraps (30, 40). The handle, pole or rod (50) is held in the user's hand adjacent to which the grip brace is attached. A wrap (30) extends from the base (20) and is pulled over one or more of the fingers (64a-64e) of the user's hand. The wrap end (32) is positioned such that wrap end fastener (36) may be engaged with its corresponding connector element. In the illustrative embodiment, the connector element is the second face (17) of the base (20), which, as discussed above, is a surface of Velcro® loops to which the Velcro® hooks of the wrap end fastener (36) can be engaged and thereby secure the wrap end (32). It should be further noted that the wrap (30) in the illustrative grip brace (10) is connected to the base (20) such that when the wrap (30) is pulled, it is pulled and positioned from the back of the hand over the non-thumb fingers (64b-64e) towards the fingertips before being engaged with the connector element. The present disclosure also contemplates that the wrap (30) may be used or configured such that it originates from base (20) and passes over one or more of the fingertips of fingers (64a-64e) and then over the back of the hand to reach the connector element.

A single finger from the opposing hand can be engaged on the gripper element, such as wrap end gripper loop (34) to move, stretch and engage the wrap end fastener (36) with the selected connector element, or the selected location on a continuous connector element such as the the Velcro® loop fabric of the base's second face (17) or the wrap's own second face (37) or other location of the grip brace (10).

It will be appreciated that wrap (30) may be of varying widths, including a sufficient width to cover all fingers (64a-64e) or any number of fingers of the hand, such that a single wrap is sufficient to secure the handle, rod or pole (50) in the user's hand.

FIG. 5 illustrates the placement and securement of an additional wrap (40). The procedure for placing this additional wrap is similar to that for the first wrap (30) and can likewise be accomplished using a single finger of the opposing hand engaged with the wrap end gripper loop (44) or other gripper element. The wrap (40) as illustrated also extends from the base (20) and is pulled over one or more of the fingers (64a-64e) of the user's hand. It should be noted that wraps, such as wrap (40), may extend from another wrap, such as wrap (30), and are not required to extend from the base (20). The wrap end (42) is positioned such that wrap end fastener (46) may be engaged with its corresponding connector element. In the illustrative embodiment, the connector element is the second face (37) of the wrap (30), which, like the second face (17) of the base end (20), is a surface of Velcro® loops to which Velcro® hooks of the wrap end fastener (46) can be engaged and thereby secure the wrap end (42). It should be noted that wrap end fasteners (46) and their corresponding connector elements may include any common fastener such as the hook section or loops section of a Velcro® fastener, a button hole button or corresponding button, any type of hook with a corresponding loop, either side of a snap fastener, or any other fastener. Such fasteners are well known and the fastener may be selected from any type that is usable by the wearer of the device or by a person assisting the wearer to don the device.

As is readily apparent, at least some embodiments of the present disclosure do not interpose any barrier between the handle, rod, or pole and the user's hand. This allows user to employ her normal tactile sensations, such as slight pole vibrations when fishing, without the interference experienced when using a glove. Further, while the illustrated handle (50) is shown as relatively smooth and generally round, the present disclosure be used in accordance with a wide array of shapes, textures, and other configurations of handles, rods, poles, racquets, and other instruments. Further, grip braces having two or more wraps may facilitate the use of embodiments of the present disclosure with irregular handles, such as some fishing poles that may have a knob or other protrusion designed to fit between fingers of the gripping hand.

Further, the base, one or more of the wraps or other features may be elastic or formed from an elastic material. The use of such elastic material allows the compression or tightness of the base and one or more wraps to be adjusted based upon how far the base or wrap is stretched prior to securing the appropriate end fastener to its connector element. Increasing the compression or tightness of the base will provide additional support to the wrist to prevent excessive wrist bending cause by forces on the handle or rod.

While this disclosure has been made with emphasis on certain embodiments, it should be understood that within the scope of the appended claims, the embodiment might be practiced other than as specifically described herein.

I claim:

1. A grip device for maintaining a grip on a handle, such as for a fishing pole, tennis racket, golf club, rake, broom, or other item, the device comprising:
a base for securing said device to a wrist of a user, said base having an anchor and a base end comprising a base end grip and a base end fastener for securing the base end to a base end connector;
at least one wrap connected to said base, said at least one wrap having a first end comprising a first grip and first fastener for securing the first wrap end to a first end connector;
wherein,
said anchor is configured to engage at least one finger of a user's hand;
the device is securable to a user's wrist by encircling said user's wrist with said base; and
the handle is securable in the user's hand by wrapping the at least one wrap around at least a portion of said user's hand and engaging the first fastener with the first end connector when said user's hand grips the handle.

2. The device of claim 1 wherein said device is securable to said user's wrist by wrapping the base around said user's wrist and engaging the base end fastener with the base end connector.

3. The device of claim 1 wherein said base comprises a first face and a second face, said second face comprising at least one of said base end connector and first end connector.

4. The device of claim 1 wherein said at least on wrap comprises a plurality of wraps.

5. The device of claim 1 wherein said base comprises an elastic material.

6. The device of claim 1 wherein said at least one wrap comprises an elastic material.

7. The device of claim 1 further comprising an elastic element which is part of the base and at least one wrap.

8. The device of claim 1 where the base and the at least one wrap comprise a continuous elastic material.

9. The device of claim 1 wherein said device permits full contact between the user's fingers and the handle.

10. The device of claim 1 wherein said base end fastener comprises a hook-and-loop fastener.

11. The device of claim 1 wherein said wrap end fastener comprises a hook-and-loop fastener.

12. The device of claim 1 wherein said base end fastener and said base end connector comprise a Velcro fastener.

13. The device of claim 3 wherein said second face comprises a material having the loop surface of a Velcro fastener.

14. A method for securing a user's grip on a handle with a grip device, the grip device comprising a base having an anchor and a base fastener and at least one wrap having a first wrap end and a first end fastener; said method comprising:
engaging a hand of the user with the anchor;
wrapping the base around the user's wrist and securing it to the wrist by engaging the base fastener with a base end connector;
wrapping the at least one wrap around the user's hand and securing the first wrap end to the first end connector while the hand grips the handle, the wrap thereby adding force to said user's grip.

15. The method of claim 14 further comprising engaging the base end grip with at least one finger of another hand to wrap the base end around the user's wrist and engage the base end fastener with the base end connector.

16. The method of claim 14 further comprising engaging the first end grip with at least one finger of another hand to wrap the first wrap end around the user's hand and engage the first end fastener with the first end connector.

17. The method of claim 14 wherein the at least one wrap comprises a plurality of wraps.

18. The method of claim 14 wherein engaging the hand of the user comprises engaging at least one finger of the user.

19. The method of claim 14 wherein engaging the hand of the user comprises engaging a thumb of the user.
